(19) United States
(12) Patent Application Publication
(10) Pub. No.: US 2022/0312700 A1
(43) Pub. Date: Oct. 6, 2022

(54) CULTIVATION ENCLOSURE FOR AGRICUTURAL ENVIRONMENT CONTROL

(71) Applicant: PANASONIC FACTORY SOLUTIONS ASIA PACIFIC, Singapore (SG)

(72) Inventors: Mun Ji LOW, Singapore (SG); Kim Leng LOH, Singapore (SG); Jing Wen, Jotina LIM, Singapore (SG)

(21) Appl. No.: 17/695,414

(22) Filed: Mar. 15, 2022

Related U.S. Application Data
(60) Provisional application No. 63/167,736, filed on Mar. 30, 2021.

(51) Int. Cl. A01G 31/00

(52) U.S. Cl. CPC A01G 31/00; A01G 2031/006

(57) ABSTRACT

A cultivation enclosure for growing crops includes a chamber. The chamber includes a base and a lid configured to cover the base. The chamber is connected to a rack. The rack includes one or more inlets and one or more outlets. The rack is configured to dispense water and minerals into the chamber through the one or more inlets or discharge water from the chamber through the one or more outlets.

### CROSS-REFERENCE TO RELATED APPLICATION

This application claims priority to U.S. Provisional Application No. 63/167,736, filed by PANASONIC FACTORY SOLUTIONS ASIA PACIFIC, on Mar. 30, 2021, and entitled CULTIVATION ENCLOSURES FOR CONTROL ENVIRONMENTAL AGRICULTURAL.

### TECHNICAL FIELD

The present disclosure relates to the field of a control system for agricultural environment, and in particular relates to controlling an enclosed environment of a cultivation chamber for growing crops.

### BACKGROUND

Growing crops at a location different from original location can be difficult. Different geographic locations may have different air pressures, different soil compositions, and different water conditions, etc. At present, to grow certain crops at a different geographic area largely depends on local seasons or climates. When the season or climate is close to that of the original location, replication of the original agricultural environment to grow a specific type of crop can be easily achieved. When the season or climate is substantially different from that of the original location, replication of the original agricultural environment to grow the specific type of crop can be difficult. Currently, indoor agricultural settings tend to mimic temperature similar to that of the original agricultural environment for the crop to grow. However, replication of the same temperature is not sufficient to render the same quality crop as in its origin.

### SUMMARY

According to one aspect of the present disclosure, a cultivation enclosure for growing crops is provided. The cultivation enclosure includes a chamber. The chamber includes a base and a lid configured to cover the base. The chamber is connected to a rack. The rack includes one or more inlets and one or more outlets. The rack is configured to dispense water and minerals into the chamber through the one or more inlets or discharge water from the chamber through the one or more outlets.

According to another aspect of the present disclosure, a control system for growing crops in a cultivation enclosure is provided. The control system includes one or more racks, a display, and a control panel. The one or more cultivation enclosures are disposed on each of the one or more racks. The one or more cultivation enclosures are interconnected with each other through the one or more racks. The control panel is located outside the chamber and at a bottom of the chamber. The control panel is configured to adjust a parameter inside the chamber. A plurality of sensors are disposed inside each chamber. Each sensor is configured to detect the parameter inside the chamber and send data corresponding to the parameter to the control panel. The display is configured to display the parameter inside the chamber. The control panel receives data from the plurality of sensors and sends an instruction to the chamber for adjusting the parameter.

According to further aspect of the present disclosure, a method for controlling crop growth in a cultivation enclosure is provided. The method includes: detecting, by a sensor located inside a chamber of the cultivation enclosure, a parameter inside the chamber; collecting, by a control panel located outside the cultivation enclosure and at a bottom of the cultivation enclosure, data from the sensor; sending, by the control panel, data collected from the sensor to a server remotely communicated with the control panel; analyzing, by the server, data received from the control panel; receiving, by the control panel, an instruction from the server; and adjusting, by the control panel, the parameter according to the instruction.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to limit the scope, the embodiments will be described and explained with additional specificity and detail through the use of the drawings below.

FIG. 1 is a schematic diagram illustrating a standalone cultivation enclosure according to some embodiments of the present disclosure;

FIG. 2 is a schematic diagram showing a plurality of cultivation enclosures interconnected with each other through a plurality of racks according to some embodiments of the present disclosure;

FIG. 3 is a schematic diagram illustrating (a) a front view of the cultivation enclosure and (b) a back view of the cultivation enclosure according to some embodiments of the present disclosure;

FIG. 4 is a schematic diagram illustrating a standalone cultivation enclosure (a) when lid closes and (b) when lid opens, according to some embodiments of the present disclosure;

FIG. 5 is a flowchart illustrating a method of controlling crop growth in one or more cultivation enclosures according to some embodiments of the present disclosure;

FIG. 6 is a block diagram illustrating a control panel of the cultivation enclosure according to some embodiments of the present disclosure; and

FIG. 7 is a schematic diagram of combined cultivation enclosures in communication with a central control according to some embodiments of the present disclosure.

### DETAILED DESCRIPTION OF THE EMBODIMENTS

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

The phrase “in some embodiments” that appears in various places throughout this specification refers to the cultivation enclosure, the control system, and the method of this disclosure for growing crops in a customizable agricultural environment in the detailed descriptions.

Specific temperature, water, air condition, or soil composition is required for a certain type of crop to grow. Different geographic locations usually are usually associated with a different agricultural environment, that is, different temperatures, water compositions, air conditions, or soil compositions, etc. To grow a type of crop in a location different from its original location requires replication of the original agricultural environment in a completely different landscape.

Certain crops may only have best quality in its origin, and oftentimes, growing the crop at a different geographic location may lead to declination of the quality of the crop. The original environment usually provides the crop with necessary nutrients and weather for its growth. Accordingly, to simply replicate the temperature for growing crops, as in the existing technologies, is not sufficient to grow the crops in the same quality as in the origin. In the present disclosure, a cultivation enclosure is used as an example to replicate original agricultural environment for growing crops. The cultivation enclosure can provide crops with optimal air pressure, soil composition, water composition, and temperature for their growth.

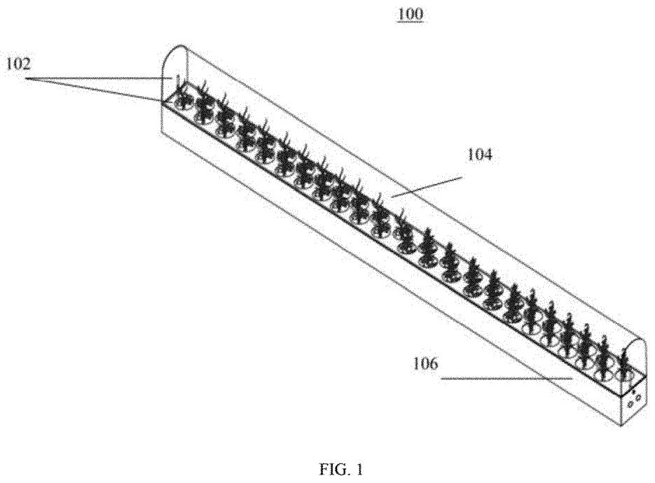

In some embodiments, the cultivation enclosure can work standalone. That is, the cultivation enclosure may operate independently. The cultivation enclosure may allow plants to grow in various geographic locations as a standalone. As shown in FIG. 1, an individual cultivation enclosure 100 may include a chamber 102. The chamber 102 may include a lid 104 and a base 106. According to the embodiments of the present disclosure, the shape of enclosure can be in various forms. For example, the cultivation enclosure may be rectangular, squarish, box concept and the like.

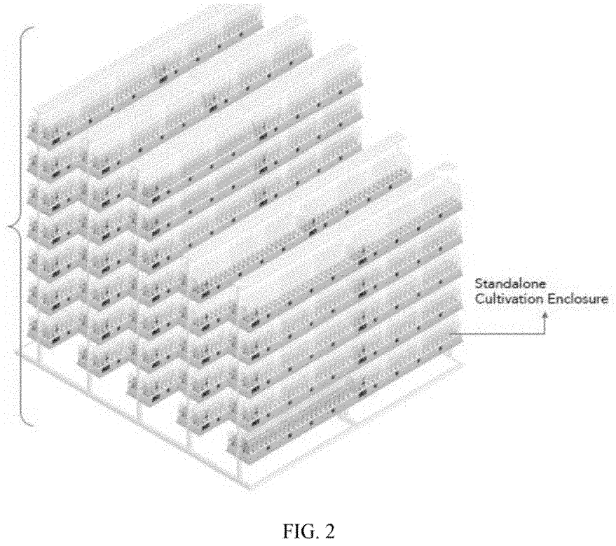

In some embodiments, the cultivation enclosure can be combined through a rack to obtain a bulk size environment for growing crops. For example, a number of N1 cultivation enclosures may be coupled to a number of N2 cultivation enclosures such that the enclosures are expanded to a bulk size. In one example, the rack can hold up to fifty cultivation enclosures. As shown in FIG. 2, a plurality of cultivation enclosures may be connected horizontally, or the plurality of cultivation enclosures may be connected vertically, or some of the plurality of cultivation enclosures may be connected horizontally while others may be connected vertically. While each of the plurality of cultivation enclosures may standalone, the combination of the plurality of the cultivation enclosures may also operate as a bulk agricultural environment for growing crops. The cultivation enclosures can be coupled to the rack, and be dislodged from rack for inspection or refilling water and nutrients for the crops. The cultivation enclosures can be powered up through the connection to the rack. Alternatively, the cultivation enclosures may also be powered up by a built-in portable battery system.

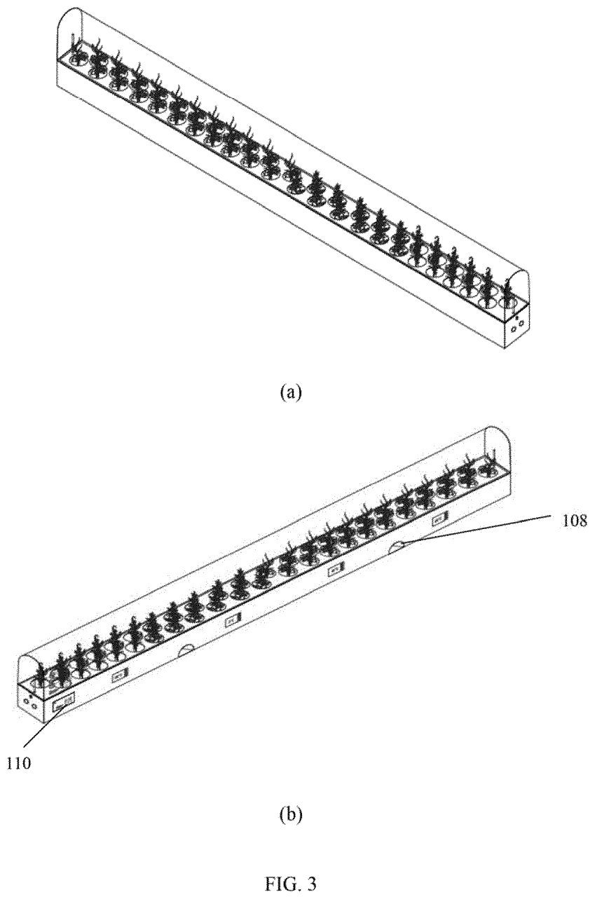

In some embodiments, the rack may dispense water or nutrients to the cultivation enclosures. In one example, the rack is connected to an external structure such as water pipes. FIG. 3(a) shows a front view of the cultivation enclosure, and FIG. 3(b) shows a back view of the cultivation enclosure. In some embodiments, as shown in FIG. 3(b), the rack is connected to the water pipes through the holes 108 located at a back of the cultivation enclosure 100. The holes 108 may be disposed at a bottom of the cultivation enclosure 100, for example, at the base 106. In some embodiments, water and nutrients can be refilled into each cultivation enclosure 100 or can be discharged from the cultivation enclosure through the holes 108. In some embodiments, the plurality of holes may be configured to be inlets for replenishing water and nutrients or drawing in air. In some other embodiments, the plurality of holes may be configured to be outlets for discharging water, minerals, or air.

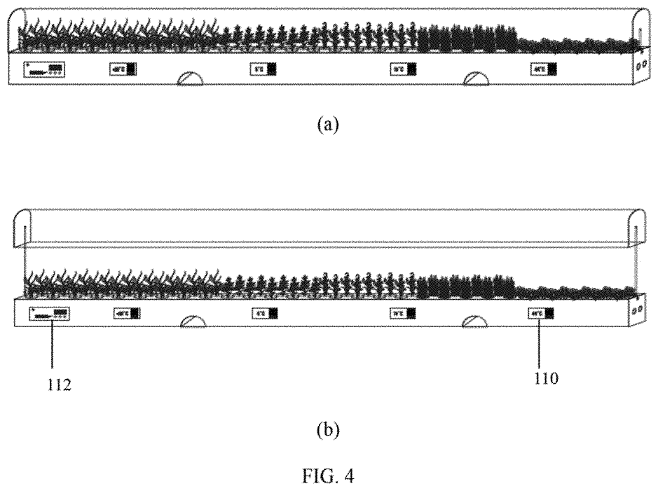

As shown in FIG. 4(a), each individual cultivation enclosure may be airtight secured. The chamber 102 may be transparent. When closed, the lid 104 is configured to cover the cultivation enclosure 100 tightly. The chamber may be made of transparent materials such as glass, acrylic and the like. The transparent chamber allows the staffs on site to be able to see through the crops. In some embodiments, by monitoring growth of the crops, onsite staffs may manually adjust the atmospheric conditions inside the chamber. On the one hand, the leakage proof design can guarantee the hygiene of the crops. On the other hand, the airtight system may draw in air to obtain an optimal air composition and air pressure for the crops. The ideal temperature, air pressure, air composition, or water composition depends on the type of the crops.

As shown in FIG. 4(b), the individual cultivation enclosure 100 may further include one or more displays 110 and a control panel 112. As shown in FIG. 3(b), the display 110 may be located near the holes 108 at the base 106. The cultivation enclosure may further include a plurality of sensors 114 located inside the chamber. Each sensor 114 is configured to detect a parameter inside the chamber. The display 110 is configured to display the growth condition of the crops. For example, the display 110 may display the parameter data collected by the sensor 114. The control panel 112 may be configured to receive data collected by the plurality of sensors 114.

In some embodiments, as shown in FIG. 4(b), the enclosure may be hoisted mechanically or via an assisted mechanism to open the lid 104 of the cultivation enclosure 100. In some other embodiments, the airtight cultivation enclosure 100 may also achieve self-cleaning without external assistance as shown in FIG. 4(a). That is, there is no need to open up the chamber of the cultivation enclosure for cleaning. For example, the cultivation enclosure can be installed with air filter, air cleaner, or a purifier to implement self-cleaning and provide a clean environment for the crops. Further, ultraviolet rays may also be installed for sterilization.

In some embodiments, the display may be a liquid crystal display (LCD). The data of the control panel 112 may be outputted via a communication system to a central control 116. The central control 116 may be, for example, a central server, a computer, a tablet, or mobile phone. The communication system may include Wide Area Network (WAN), Wireless Lan (WLAN), Wi-Fi, Bluetooth, 4G, 5G, etc. The central control 116 can monitor and control the inter-connected cultivation enclosures. All conditions of each cultivation enclosure can be monitored closely through the central control 116. In one example, the central control 116 may control the individual rack to provide artificial light for growing the crop. A proper portion of light may be controlled by the central system to provide to each crop. Sources for the artificial light may include light emitting diode (LED), micro-lasers, redirected natural lights, and the like. In another example, the central control 116 may send an instruction to the control panel 112 located at the bottom of the enclosure such that the control panel 112 may adjust a parameter inside the chamber. The data may be displayed on an application software installed on a mobile terminal such as a mobile device, personal computer (PC), tablet and the like. In some other embodiments, the data can also be shown both on the control panel locally or the application remotely. In some embodiments, the enclosure may be dislodged from the rack and taken to another location, for example, the location of the central control 116, for data transmission.

According to some embodiments of the present disclosure, the plurality of sensors 114 may be located within the cultivation enclosure near the position the sensor detects or monitors. The sensors 114 may be configured to measure temperature, air pressure, humidity, and so forth. For example, a hundred sensors may be connected to the rack for measurement and data collection. In some embodiments, a specific sensor located on the rack to monitor other sensors from being dislodged from the rack may also be provided. In one example, the entire mechanism may include 100 racks inter-connected with each other. In some embodiments, a surveillance camera may be used to monitor the entire mechanism. Accordingly, a scalable environment for growing crops may be achieved by inter-connecting racks and individual enclosures.

When the plurality of sensors 114 operate inside a standalone cultivation enclosure 100, the sensors 114 may operate in collaboration with each other and interpret the standalone enclosure 100 as an entire environment. Each of the sensors is configured to detect one parameter that contributes to the growth of the crops. Subject to products requirement, the cultivation enclosure may consist of a combination of different sensors such as but not limited to optical, PH, global positioning system (GPS), accelerometer, camera, oxygen, carbon dioxide, airflow, lidar, gas, weather, temperature, humidity, yield, mapping, and so forth.

In some embodiments, the sensors may be capable of collect data in real-time and send the data to the control system to allow the real-time feedback control of the environment.

According to some embodiments of the present disclosure, the local control panel 112 may collect data from the sensors 114 and after sensor data is collected, the control panel 112 may determine whether to send data to the central control 116.

Data may be collected and analyzed after data collection to obtain adjustment data for adjusting one or more parameters inside the chamber 102. For example, a thermometer can be used to measure a temperature inside the cultivation enclosure. The thermometer may be used to determine a temperature adjustment that promotes growth of the crops. In some embodiments, a range that the thermometer can measure may vary from −40° C. to 50° C. In one example, after the thermometer measures the temperature inside the chamber to be 24° C., the central control 116 determines that the temperature needs to be increased by 1° C. to promote growth of the crop, the central control 116 sends an instruction the control panel 112. The control panel 112 may adjust the temperature inside the chamber to be 1° C. higher than the measurement temperature. Accordingly, an automatic adjustment of the temperature of an airtight environment inside the chamber can be implemented.

According to some embodiments of the present disclosure, the cultivation enclosure 100 may include multiple pots 118 at the base 106. The multiple pots 118 may contain mediums for growing crops. The multiple pots 118 may have access to water and minerals refill system. In some embodiments, the medium can be soil, hydroponics, zeolite, non-liquid base, liquid base and the like.

Therefore, a highly intelligent cultivation enclosure for growing crops in any geographic location in the world is provided in the present disclosure. According to the embodiments of the present disclosure, by setting optimal growth conditions, monitoring and adjusting the actual conditions inside the chamber, cultivation enclosures of the embodiments of the present disclosure may be capable of replicating the best condition of growth to yield top quality crops and grow all-year-round special vegetables and herbs.

In some embodiments, a miniature water reservoir 120 may be disposed in the cultivation enclosure. In one example, the water reservoir 120 is located at a bottom of the rack beneath the crops. In some embodiments, the water reservoir 120 can storage water sufficient for the crop in up to two days. The water reservoir 120 may be also connected to an adjacent rack such that the control system may release water to the cultivation chamber to the water reservoir through the rack. The water reservoir may include a water pump to draw in water from the rack. The water pump allows water to be refilled from the outside of the chamber 102.

According to the embodiments of the present disclosure, all racks may share the same central control 116. When the individual cultivation enclosures 100 are combined with each other, each may be automatically connected with a designated rack such that the cultivation enclosure 100 can be replenished with nutrients from outside. In some embodiments, the rack may be categorized based on the type of the crops to grow. For example, a same type of crops may share a common rack, and different types of crops may be located on different racks. In some embodiments, multiple types of crops can be grown within the same cultivation enclosure, subject to different temperature and atmosphere at different portions of the enclosure. Each portion may include one or more pots 118 containing mediums accessible to the water and nutrients refill system.

The refilling of water and nutrients may require the individual enclosure 100 to be dislodged from the rack, and transported to a centralized location 122 so that refill can be done automatically at the centralized location 122. In some embodiments of the present disclosure, the centralized location 122 may also operate an inspection system.

At the harvest season, the cultivation enclosure 100 can implement automatic harvest by a cutting system inside the chamber 102. The cutting system may include a built-in knife and the like.

Therefore, a customizable cultivation enclosure for growing crops may be implemented through combination of individual cultivation enclosures through a centralized system based on the actual need. By this scalable design of the cultivation enclosures, a bulk volume can be obtained for growing crops. The ease of transportation of the cultivation enclosures, whether standalone, or in combination, allows different venues for urban farming. Because of the Internet of Things (IoT) infrastructure of the customizable enclosure, the reproduction of optimal conditions for growing crops can be implemented inside the chamber. Certain high atmospheric plants can grow due to the intelligent atmospheric control.

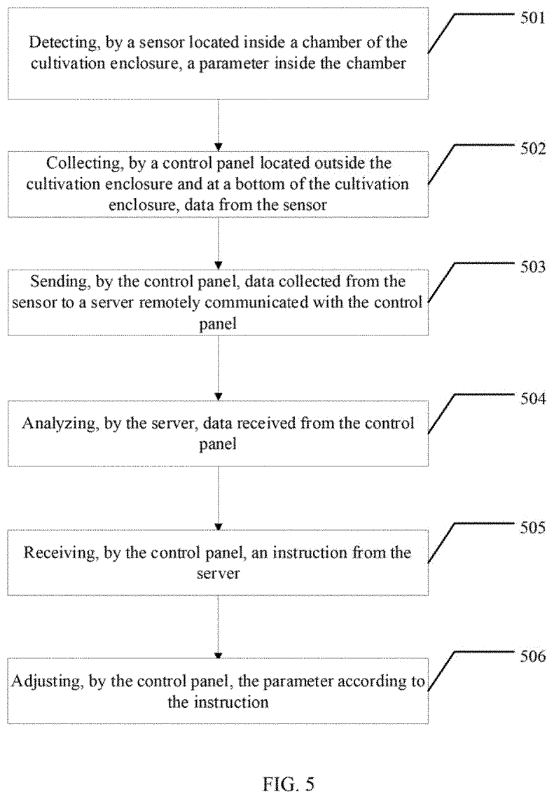

According to some embodiments of the present disclosure, as shown in FIG. 5, a method for controlling crop growth in a cultivation enclosure is provided.

FIG. 5 is a flowchart illustrating a method of controlling crop growth in one or more cultivation enclosures.

Step 501: Detecting, by a sensor located inside a chamber of the cultivation enclosure, a parameter inside the chamber.

In step 501, each of the plurality of sensors 114 may be configured to detect a parameter inside the chamber 102. The parameter may reflect one aspect of growth condition of the crops. Accordingly, the plurality of sensors can detect a plurality of parameters inside the chamber such that the plurality of parameters, as a whole, can reflect the overall growth condition of the crops.

Step 502: Collecting, by a control panel located outside the cultivation enclosure and at a bottom of the cultivation enclosure, data from the sensor.

In step 502, after the plurality of sensors detect corresponding parameters inside the chamber, the control panel 112 may collect data from the plurality of sensors 114. The control panel 112 may be located outside the cultivation enclosure 100 and at a bottom of the cultivation enclosure 100.

Step 503: Sending, by the control panel, data collected from the sensor to a server remotely communicated with the control panel.

In step 503, the control panel 112 may send data collected from the plurality of sensors 114 to a central control 116. The central control may be, for example, a server. The server may be remotely communicated with the control panel.

In some embodiments, the central control 116 may be a mobile terminal. The mobile terminal may be a computer, a laptop, a tablet, or a mobile phone. The mobile terminal may be installed with an application software configured to remotely control the cultivation enclosures.

Step 504: Analyzing, by the server, data received from the control panel.

In step 504, the server may analyze the data received from the control panel 112. Such data may render a result that reflect growth conditions inside the chamber 102. In one example, if a result obtained from analyzing the data indicates that the chamber 102 lacks oxygen, the server may then take this factor into consideration and generate an instruction to be sent to the control panel 112. In another example, if a result obtained from analyzing data indicates that the artificial light inside the chamber 102 is too dim, the server may then take this factor into consideration and generate an instruction to be sent to the control panel 112.

Step 505: Receiving, by the control panel, an instruction from the server.

In step 505, the control panel 112 may receive an instruction from the server. The instruction may contain the information on subsequent operations to achieve an optimal condition for growing the crops inside the chamber 102. The optimal condition may include one or more aspects of growth factors.

Step 506: Adjusting, by the control panel, the parameter according to the instruction.

In step 506, the control panel 112 may adjust the parameter inside the chamber 102 based on the instruction received from the server. The adjustment may promote ultimate conditions for growing crops in their original quality.

Based on the method for controlling crop growth of the embodiments of the present disclosure, an automatic adjustment of parameters associated with an airtight environment inside the chamber can be implemented. Therefore, the crops can grow in the optimal environment for its growth regardless of the geographic locations. The ease of combination and transportation of the cultivation enclosures also fulfills urban farming in a customizable manner.

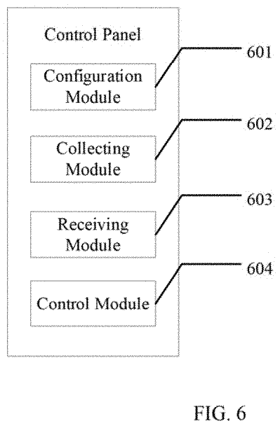

FIG. 6 is a block diagram illustrating a control panel of the cultivation enclosure according to some embodiments of the present disclosure.

In some embodiments, the control panel of the present disclosure may also include a plurality of modules. The plurality of modules may include: a configuration module 601 configured to enable manual setting up of the parameters inside the chamber; a collecting module 602 configured to collect data from each of the plurality of sensors; a receiving module 603 configured to receive an instruction from a server remotely communicated with the control panel; and a control module 604 configured to be connected to a device of the chamber for adjusting the corresponding parameter inside the chamber.

As shown in FIG. 6, the control panel 112 may include a configuration module 601, a collecting module 602, a receiving module 603, and a control module 604.

The configuration module 601 may be configured to set initial parameters corresponding to the airtight environment inside the chamber 102. The configuration module 601 may be further configured to set an optimal parameter for crop growth corresponding to a condition inside the airtight environment. The collecting module 602 may be configured to collect data from the plurality of sensors 114. The data indicates parameters detected by the plurality of sensors 114. The receiving module 603 may be configured to receive an instruction from a server remotely communicated with the control panel 112. Upon receiving the instruction from the server, the control module 604 of the control panel 112 may be configured to adjust a parameter associated with the airtight environment inside the chamber. The control module 604 may control a device located inside the chamber 102 to adjust the parameter.

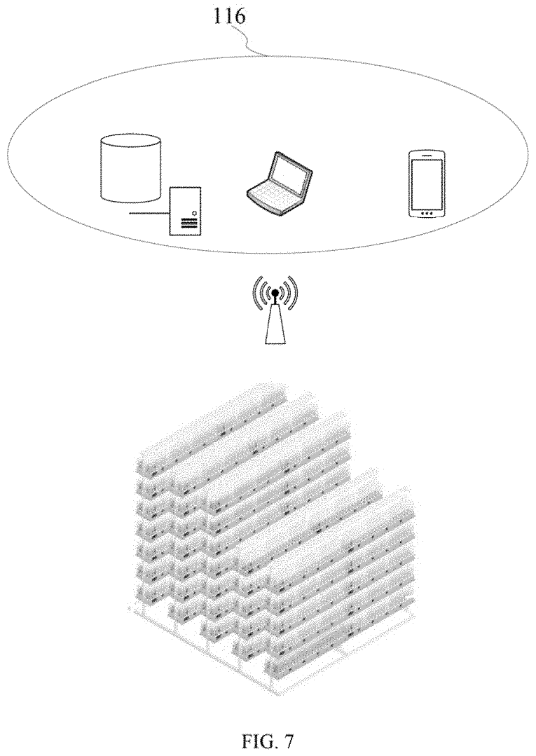

In the foregoing described embodiments, the implementation of growing crops in the cultivation enclosure is within an Internet of Things (IoT) infrastructure. FIG. 7 is a schematic diagram of the combined cultivation enclosures in communication with central control according to some embodiments of the present disclosure. As shown in FIG. 7,

A person skilled in the art should recognize, however, that the embodiments of the present disclosure may also be implemented in a computer program product disposed upon a computer-readable storage medium having computer readable program instructions for causing the server to carry out the foregoing described method.

The computer-readable storage medium can be a tangible device for storing instructions. The computer-readable storage medium includes flash drive, movable hard disks, read-only memory (ROM), random-access memory (RAM), magnetic disks or optical disks, and other mediums that can store program codes.

Computer-readable program instructions described herein can be downloaded to respective computing/processing devices from the computer-readable storage medium or to an external computer or external storage device via a network, for example, the Internet, a LAN, a WAN, or a wireless network.

Computer-readable program instructions for carrying out the method embodiment of the present disclosure may be assembler instructions, instruction-set architecture (ISA) instructions, machine instructions, machine dependent instructions, microcode, firmware instructions, state-setting data, or other source code or object code written in any combination of one or more programming languages.

The computer-readable program instructions may execute entirely on a mobile terminal, partly on the mobile terminal, as a standalone software package, partly on the mobile terminal and partly on the server or entirely on the server.

The above description of the disclosed embodiments of the present disclosure can enable those skilled in the art to implement or use the present disclosure. Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A cultivation enclosure for growing crops, comprising:
a chamber including a base and a lid configured to cover the base, the chamber being connected to a rack, the rack including one or more inlets and one or more outlets, wherein the rack is configured to dispense water and minerals into the chamber through the one or more inlets or discharge water from the chamber through the one or more outlets.

2. The cultivation enclosure according to claim 1, wherein one or more sensors are disposed inside the chamber and configured to detect a parameter inside the chamber and collect data corresponding to the parameter.

3. The cultivation enclosure according to claim 2, wherein a display is disposed outside the chamber and at a bottom of the chamber, and the display is configured to display data collected from the one or more sensors.

4. The cultivation enclosure according to claim 3, wherein the sensors include one or more of a thermometer, a global positioning system (GPS) sensor, an optical sensor, accelerometer, a camera, a gas sensor, a PH sensor, and a humidity sensor.

5. The cultivation enclosure according to claim 2, further comprising:
a control panel disposed outside the chamber and at a bottom of the chamber, wherein the control panel is configured to receive data from one or more sensors disposed inside the chamber.

6. The cultivation enclosure according to claim 2, wherein the cultivation enclosure is connected with a remote server configured to receive data from one or more sensors disposed inside the chamber, analyze the data, and adjust a parameter inside the chamber according to a result obtained from analyzing the data.

7. The cultivation enclosure according to claim 5, wherein:
the one or more sensors are configured to detect a parameter inside the chamber and collect data corresponding to the parameter; and
the control panel is further configured to adjust the parameter according to the data collected from the one or more sensors.

8. The cultivation enclosure according to claim 7, wherein the control is further configured to, before adjusting the parameter:
send the data to a control system for analyzing data, wherein the control system sends an instruction to the control panel based on a result obtained from analyzing the data; and
adjust, according to the result obtained from analyzing the data, the parameter corresponding to the sensor.

9. The cultivation enclosure according to claim 1, wherein:
the cultivation enclosure is airtight,
the chamber is transparent, and
the lid elevates to open the chamber or slides down to close the chamber.

10. The cultivation enclosure according to claim 1, wherein:
the cultivation enclosure is a first cultivation enclosure; and
the rack includes a second cultivation enclosure and a third cultivation enclosure interconnected with the first cultivation enclosure and the second cultivation enclosure through the rack.

11. The cultivation enclosure according to claim 1, wherein:
the cultivation enclosure is a first cultivation enclosure, and the rack is a first rack; and
the first rack is coupled to a second rack, the second rack including a second cultivation enclosure and a third cultivation enclosure interconnected with each other through the second rack.

12. The cultivation enclosure according to 1, wherein the cultivation enclosure is dislodged from the rack for inspection and/or refilling water and nutrients.

13. A control system for growing crops in a cultivation enclosure, comprising:
one or more racks, one or more cultivation enclosures being disposed on each of the one or more the racks, the one or more cultivation enclosures being interconnected with each other through the one or more racks;
a display;
a control panel located outside the chamber and at a bottom of the chamber, the control panel being configured to adjust a parameter inside the chamber, wherein:
a plurality of sensors are disposed inside each chamber, each sensor being configured to detect the parameter inside the chamber and send data corresponding to the parameter to the control panel;
the display is configured to display the parameter inside the chamber; and
the control panel receives data from the plurality of sensors and sends an instruction to the chamber for adjusting the parameter.

14. The control system according to claim 13, further comprises:
a server remotely communicated with the control panel,
wherein the server is configured to receive data sent from the control panel, analyze the data, and send an instruction to the control panel based on a result obtained from analyzing the data.

15. The control system according to claim 13, wherein the control panel comprises:
a configuration module configured to set up parameters for each of the one or more cultivation enclosures;
a collecting module configured to collect data from each of the one or more sensors;
a receiving module configured to receive an instruction from a server remotely communicated with the control panel; and
a control module configured to be connected to a device of the chamber to adjust a parameter inside the chamber.

16. The control system according to claim 13, wherein the control system further comprises a determination module configured to determine whether the data collected by the one or more sensors satisfy a predetermined condition.

17. The control system according to claim 13, wherein:
the cultivation enclosure is airtight,
the chamber is transparent, and
the lid elevates to open the chamber or slides down to close the chamber.

18. The control system according to claim 13, wherein the cultivation enclosure is dislodged from the rack for inspection and/or refilling water and nutrients.

19. The control system according to claim 13, wherein the one or more racks are configured to dispense water and nutrients to the one or more cultivation enclosures.

20. A method for controlling crop growth in a cultivation enclosure, comprising:
detecting, by a sensor located inside a chamber of the cultivation enclosure, a parameter inside the chamber;
collecting, by a control panel located outside the cultivation enclosure and at a bottom of the cultivation enclosure, data from the sensor;
sending, by the control panel, data collected from the sensor to a server remotely communicated with the control panel;
analyzing, by the server, data received from the control panel;
receiving, by the control panel, an instruction from the server; and
adjusting, by the control panel, the parameter according to the instruction.
